(19) United States
(12) Patent Application Publication
(10) Pub. No.: US 2026/0171517 A1
(43) Pub. Date: Jun. 18, 2026

(54) WIRELESS BATTERY MANAGEMENT SYSTEM AND AN OPERATING METHOD THEREOF

(71) Applicants: HYUNDAI MOTOR COMPANY, Seoul (KR); KIA CORPORATION, Seoul (KR)

(72) Inventor: Hyunki Cho, Hwaseong-si (KR)

(73) Assignees: HYUNDAI MOTOR COMPANY, Seoul (KR); KIA CORPORATION, Seoul (KR)

(21) Appl. No.: 19/243,502

(22) Filed: Jun. 19, 2025

(30) Foreign Application Priority Data
Dec. 17, 2024 (KR) 10-2024-0188517

(51) Int. Cl. H01M 10/42; H01M 10/48

(52) U.S. Cl. CPC H01M 10/425; H01M 10/482; H01M 2010/4271; H01M 2010/4278

(57) ABSTRACT

A wireless battery management system includes a plurality of cell monitoring units (CMUs) configured to monitor a plurality of battery cells, and a battery management unit (BMU) configured to perform wireless communication with the plurality of CMUs and manage the plurality CMUs. The BMU requests transmission of cell monitoring information from the plurality of CMUs, and based on a failure of the transmission from any CMU, preferentially requests retransmission of the cell monitoring information from the CMU from which transmission has failed.

### CROSS-REFERENCE TO RELATED APPLICATION

This present application claims the benefit of priority to Korean Patent Application No. 10-2024-0188517, filed on Dec. 17, 2024, in the Korean Intellectual Property Office, the entire disclosure of which is incorporated herein by reference.

### FIELD

The present disclosure relates to a wireless battery management system and an operating method thereof, and more specifically, to a wireless battery management system and an operating method thereof for controlling a high-voltage battery used in an electric vehicle or the like.

### BACKGROUND

Batteries used in environmentally friendly vehicles such as electric vehicles (EVs), hybrid electric vehicles (HEVs), and plug-in hybrid electric vehicles (PHEVs) are high-voltage batteries that generate high voltage by connecting numerous battery cells of the same specifications in series/parallel.

A battery management system (BMS) is a device that controls and manages charging and discharging of such high-voltage batteries composed of numerous battery cells, and a BMS includes a plurality of monitoring units (CMUs) that monitor the battery cells and a battery management unit (BMU) that manages the plurality of CMUs.

Battery management systems can be classified into wired battery management systems and wireless battery management systems, depending on the communication method between the plurality of CMUs and the BMU. The wired battery management system connects the plurality of CMUs and the BMU via wired cables, thus providing relatively stable communication, but uses numerous cables and connectors, thus increasing the weight of the vehicle by several tens of kilograms. On the other hand, the wireless battery management system interconnects the plurality of CMUs and the BMU through wireless communication, thus significantly reducing the weight and volume of a battery pack, but may impair communication performance due to the external noise environment and the mounting position/direction of the CMUs.

To address these shortcomings, the wireless battery management system requests retransmission of cell monitoring information from a CMU from which transmission has failed during an initial transmission period (first transmission period). However, in wireless battery management systems according to existing technology, all of the CMUs retransmit cell monitoring information during a subsequent transmission period (second transmission period), regardless of whether the transmission was successful during the initial transmission period, and therefore, the communication success rate is low because a CMU from which transmission has failed during the first transmission period may repeatedly fail to transmit in the subsequent transmission period.

The statements in this Background section merely provide background information related to the present disclosure and may not constitute prior art.

### SUMMARY

The present disclosure may provide a wireless battery management system and an operating method thereof wherein, when transmission from any CMU fails in wireless communication between a plurality of CMUs and a BMU, retransmission is preferentially performed for a CMU from which transmission has failed.

The present disclosure may further provide a wireless battery management system and an operating method thereof wherein, during wireless communication between a plurality of CMUs and a BMU, the BMU broadcasts an advertising packet including identification information of a CMU from which transmission has failed, and the CMU from which transmission has failed preferentially retransmits cell monitoring information to the BMU.

The present disclosure may further provide a wireless battery management system and an operating method thereof which sets a transmission priority for all CMUs, and when there is a plurality of CMUs from which transmission has failed, allows each CMU of the plurality of CMUs from which transmission has failed to retransmit cell monitoring information to the BMU based on the transmission priority.

The present disclosure is not limited to the above, and other aspects and advantages not mentioned above should be understood from the following description, and become more apparent from embodiments. Moreover, aspects of the present disclosure may be realized by the means and combinations thereof indicated in claims.

According to one aspect of the present disclosure, a wireless battery management system includes: a plurality of cell monitoring units (CMUs) configured to monitor a plurality of battery cells; and a battery management unit (BMU) configured to perform wireless communication with the plurality of CMUs and manage the plurality CMUs. The BMU requests the plurality of CMUs to transmit cell monitoring information, and based on a failure of the transmission from at least one CMU, preferentially requests retransmission of the cell monitoring information from the at least one CMU from which the transmission has failed (e.g., the at least one CMU that experienced the failure of the transmission).

The BMU may broadcast, to the plurality of CMUs, an advertising packet requesting the transmission of cell monitoring information. Each CMU of the plurality of CMUs may transmit cell monitoring information to the BMU during a first transmission period. Based on the failure of the transmission from at least one CMU, the BMU may broadcast, to the plurality of CMUs, an advertising packet including identification information of the at least one CMU from which transmission has failed, and the at least one CMU from which transmission has failed may retransmit the cell monitoring information to the BMU during a second transmission period.

When or based on that there are two or more CMUs from which the transmission has failed, the BMU may broadcast an advertising packet including identification information of the two or more CMUs from which the transmission has failed, and each CMU of the two or more CMUs from which the transmission has failed may retransmit cell monitoring information to the BMU during a corresponding time slot of the second transmission period. The corresponding time slot of the second transmission period may be set based on a transmission priority or be assigned to each CMU, among the two or more CMUs from which the transmission has failed, based on the transmission priority.

According to another aspect of the present disclosure, an operating method for a wireless battery management system includes: requesting, by a battery management unit (BMU), transmission of cell monitoring information from a plurality of cell monitoring units (CMUs); transmitting, by each CMU of the plurality of CMUs, the cell monitoring information to the BMU during a first transmission period; preferentially requesting, by the BMU and based on a failure of the transmission from at least one CMU, retransmission of the cell monitoring information from the at least one CMU from which transmission has failed; and retransmitting, by the at least one CMU from which transmission has failed, the cell monitoring information to the BMU during a second transmission period.

Requesting the transmission of the cell monitoring information may include broadcasting, by the BMU, to the plurality of CMUs, an advertising packet requesting the transmission of the cell monitoring information. Preferentially requesting the retransmission of the cell monitoring information may include broadcasting, by the BMU, to the plurality of CMUs, an advertising packet including identification information of the at least one CMU from which transmission has failed.

When or based on that there are two or more CMUs from which the transmission has failed, preferentially requesting the retransmission of the cell monitoring information may include: broadcasting, by the BMU, to the plurality of CMUs, an advertising packet including identification information of the two or more CMUs from which transmission has failed. Retransmitting the cell monitoring information to the BMU may include retransmitting, by each CMU of the two or more CMUs from which transmission has failed, the cell monitoring information to the BMU during a corresponding time slot of a second transmission period. The corresponding time slot of the second transmission period may be set based on a transmission priority.

According to one or more embodiments of the present disclosure, when transmission from any CMU fails in wireless communication between a plurality of CMUs and a BMU, retransmission is preferentially performed for the CMU from which transmission has failed, thereby mitigating degradation in communication performance caused by external noise that may occur in the wireless communication environment, the mounting position/direction of the CMU, and the like.

In addition, according to one or more embodiments of the present disclosure, a transmission priority is set for all CMUs, and when there is a plurality of CMUs from which transmission has failed, each of the plurality of CMUs from which transmission has failed retransmit cell monitoring information based on the transmission priority, thereby significantly improving the communication success rate, and accordingly enhancing communication performance

### BRIEF DESCRIPTION OF THE DRAWINGS

The foregoing and other aspects, features, and advantages, as well as the following detailed description of embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a block diagram of a wireless battery management system according to one embodiment of the present disclosure.

FIG. 2 is a flow chart illustrating an operating method for a wireless battery management system according to one embodiment of the present disclosure.

FIG. 3 illustrates a retransmission method of a wireless battery management system according existing technology.

FIG. 4 illustrates a retransmission method of a wireless battery management system according to one embodiment of the present disclosure.

### DETAILED DESCRIPTION

Embodiments disclosed in the present specification are described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. In relation to describing the present disclosure, when the detailed description of the relevant known technology is determined to unnecessarily obscure the gist of the present disclosure, the detailed description may be omitted. Furthermore, it should be understood that the appended drawings are intended only to help understand embodiments disclosed in the present document and do not limit the technical principles and scope of the present disclosure. Rather, it should be understood that the appended drawings include all of the modifications, equivalents or substitutes described by the technical principles and belonging to the technical scope of the present disclosure.

Although the terms first, second, third, and the like may be used herein to describe various elements, components, regions, layers, and/or sections, these elements, components, regions, layers, and/or sections should not be limited by these terms. These terms are only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

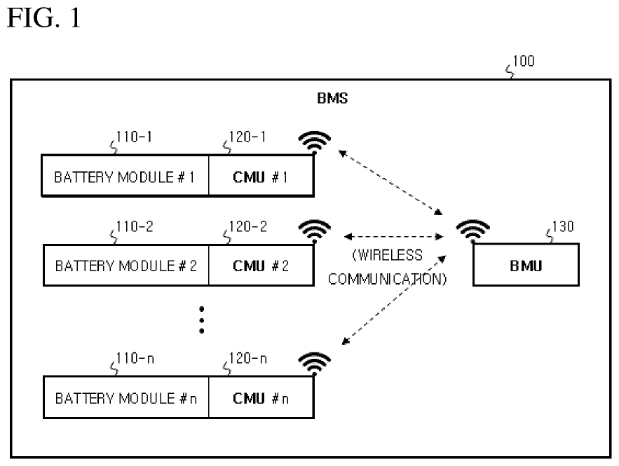

Hereinafter, a wireless battery management system and an operating method thereof according to an embodiment of the present disclosure will be described in detail with reference to FIGS. 1 to 4.

FIG. 1 is a block diagram illustrating a wireless battery management system according to one embodiment of the present disclosure.

Referring to FIG. 1, a wireless battery management system (100) according to one embodiment of the present disclosure includes a plurality of battery modules (110-1, 110-2, . . . , 110-n), a plurality of cell monitoring units (CMUs) (120-1, 120-2, . . . , 120-n), and a battery management unit (BMU) (130).

The battery modules (110-1, 110-2, . . . , 110-n) are battery assemblies composed of one or more battery cells (e.g., 32 battery cells) connected in series and/or parallel.

The CMUs (120-1, 120-2, . . . , 120-n) are devices that monitor the battery cells of the battery modules (110-1, 110-2, . . . , 110-n).

For example, the CMU (120-1, 120-2, . . . , 120-n) senses voltage, temperature, and the like of the battery cells of the battery modules (110-1, 110-2, . . . , 110-n) and generates cell monitoring information, and transmits the cell monitoring information to the BMU (130) according to a request of the BMU (130).

The BMU (130) is a device that communicates wirelessly with the plurality of CMUs (120-1, 120-2, . . . , 120-n) to manage the CMUs (120-1, 120-2, . . . , 120-n).

For example, the BMU (130) broadcasts an advertising packet requesting transmission of cell monitoring information to the plurality of CMUs (120-1, 120-2, . . . , 120-n), and controls the plurality of CMUs (120-1, 120-2, . . . , 120-n) based on the cell monitoring information received from the plurality of CMUs (120-1, 120-2, . . . , 120-n), thereby performing charge/discharge control and cell balancing, and the like for battery cells.

In addition, if transmission of cell monitoring information from any CMU (120-1, 120-2, . . . , 120-n) fails, the BMU (130) broadcasts an advertising packet including identification information of the CMU from which transmission has failed, and enables the cell monitoring information of the CMU from which transmission has failed to be preferentially retransmitted. It is advantageous to use node information of the CMU as the identification information of the CMU.

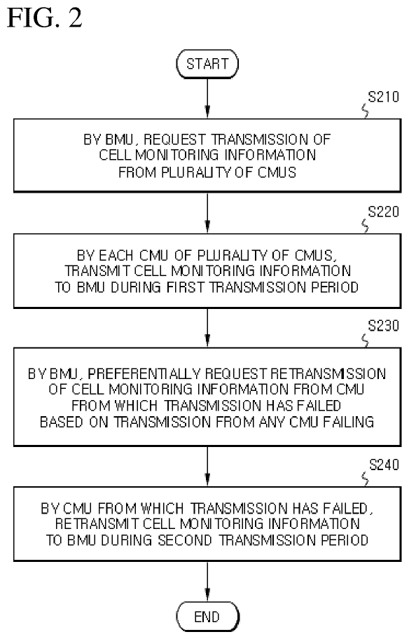

FIG. 2 is a flow chart illustrating an operating method for a wireless battery management system according to one embodiment of the present disclosure.

First, at step S210, the BMU (130) requests transmission of cell monitoring information from the plurality of CMUs (120-1, 120-2, . . . , 120-n).

For example, the BMU (130) broadcasts an advertising packet requesting transmission of cell monitoring information to the plurality of CMUs (120-1, 120-2, . . . , 120-n).

Among an advertising indication (ADV_IND) packet type, a directed advertising indication (ADV_DIRECT_IND) packet type, a non-connectable advertising indication (ADV_NONCONN_IND) packet type, and a scannable advertising indication (ADV_SCAN_IND) packet type, the advertising indication (ADV_IND) packet type is advantageous, as it does not specify a device and can be connected to all nearby devices. A payload of the advertising packet includes information requesting transmission of cell monitoring information from all the CMUs (120-1, 120-2, . . . , 120-n).

According to one embodiment of the present disclosure, the information requesting transmission of cell monitoring information from all the CMUs (120-1, 120-2, . . . , 120-n) may be implemented in the form of a specific command (e.g., ALL CMU), or may be implemented as information in the form of a flag identifying the CMUs (120-1, 120-2, . . . , 120-n) to transmit the cell monitoring information.

When the identification information of the CMUs (120-1, 120-2, . . . , 120-n) to transmit cell monitoring information is implemented in the form of a flag, the BMU (130) may indicate a transmission request to corresponding CMUs by using bits corresponding to the number of CMUs (120-1, 120-2, . . . , 120-n). For example, if there are 16 CMUs (CMU #1, CMU #2, . . . , CMU #16), the BMU (130) may request all 16 CMUs to transmit cell monitoring information by indicating “1111 1111 1111 1111”.

Then, at step S220, each CMU of the plurality of CMUs (120-1, 120-2, . . . , 120-n) transmit cell monitoring information to the BMU (130) during a first transmission period.

For example, the plurality of CMUs (120-1, 120-2, . . . , 120-n) receive an advertising packet broadcast by the BMU (130) and analyze the information included in the payload of the advertising packet to determine whether there is a transmission request for cell monitoring information. As in step S210, when there is a transmission request for cell monitoring information for all the CMUs (120-1, 120-2, . . . , 120-n), each of the CMUs (120-1, 120-2, . . . , 120-n) transmits its cell monitoring information to the BMU (130) during its own predetermined time slot within the first transmission period (i.e., during a time slot allocated to it in the first transmission period). For reference, a transmission period consists of n time slots corresponding to the number of CMUs.

During the process in which all the CMUs (120-1, 120-2, . . . , 120-n) sequentially transmit cell monitoring information to the BMU (130), transmission failure may occur due to the external noise environment, the mounting position/direction of the CMU, or the like.

In such case, as described above, retransmission is required for the CMUs from which transmission has failed.

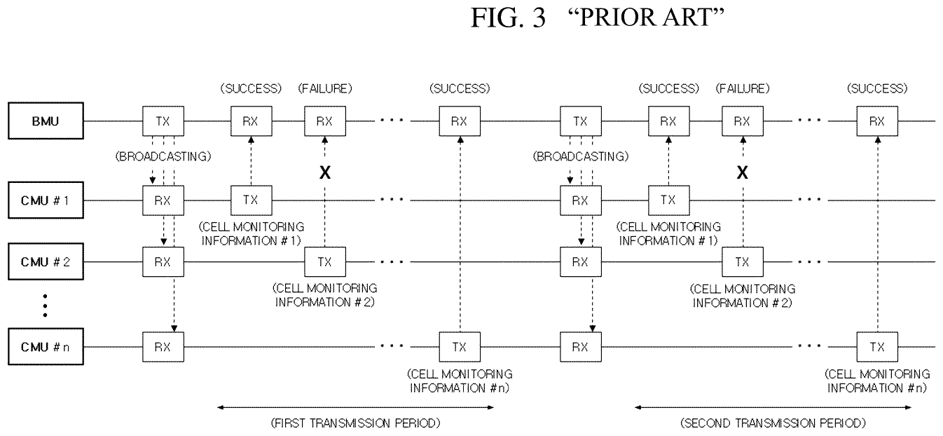

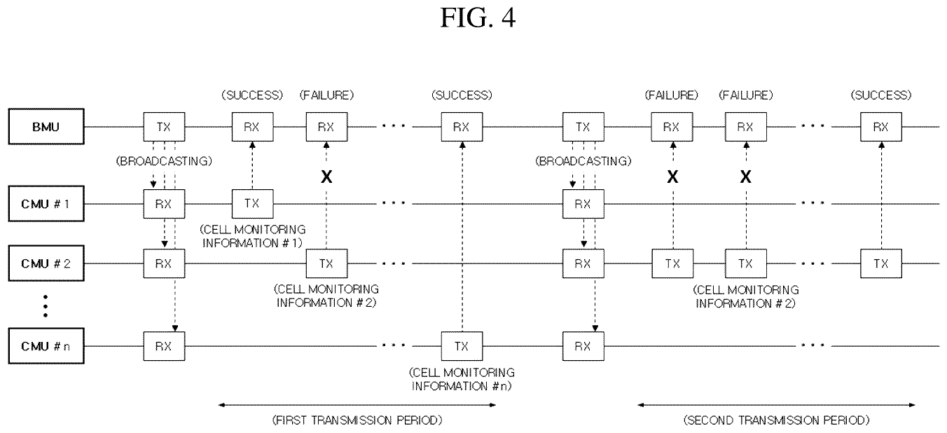

In this regard, FIG. 3 illustrates a retransmission method of a wireless battery management system according existing technology, and FIG. 4 illustrates a retransmission method of a wireless battery management system according to one embodiment of the present disclosure.

Referring to FIG. 3, in a wireless battery management system according to existing technology, when transmission of cell monitoring information from any CMU (CMU #2 in FIG. 3) fails during the first transmission period, another request for transmission of cell monitoring information is made to all the CMUs (CMU #1 to CMU #n) during a subsequent second transmission period. However, in such case, a CMU from which transmission has failed may repeatedly fail to transmit, resulting in a low communication success rate in the existing technology.

However, the wireless battery management system according to an embodiment of the present disclosure significantly improves the communication success rate by, during a second transmission period, preferentially requesting retransmission only for CMUs from which transmission has failed.

Referring to FIGS. 2 and 4, at step S230, when transmission from any CMU fails, the BMU (130) preferentially requests retransmission of cell monitoring information from the CMU from which transmission has failed (CMU #2 in FIG. 4).

For example, the BMU (130) broadcasts, to all the CMUs (120-1, 120-2, . . . , 120-n), an advertising packet including identification information of the CMU from which transmission has failed.

In such a case, it is advantageous for the advertising packet to be of the ADV_IND packet type, which does not specify a particular device and can be received by all nearby devices, and the payload of the advertising packet includes the identification information of the CMU from which transmission has failed.

According to one embodiment of the present disclosure, the identification information of the CMU from which transmission has failed may be implemented in the form of a flag. For example, if CMU #2 among 16 CMUs (CMU #1, CMU #2, . . . , CMU #16) fails to transmit, the BMU (130) indicates this as “0000 0000 0000 0010,” and if CMUs #2, #9, and #16 fail to transmit, the BMU (130) indicates this as “1000 0001 0000 0010,” thereby notifying all the CMUs (120-1, 120-2, . . . , 120-n) of the CMUs from which transmission failed.

Then, at step S240, the CMU from which transmission has failed retransmits cell monitoring information to the BMU (130) during the second transmission period. If there are a plurality of CMUs from which transmission failed, each of the plurality of CMUs from which transmission failed retransmits its cell monitoring information to the BMU (130) during its own allocated time slot in the second transmission period, based on a transmission priority.

Specifically, all of the CMUs (120-1, 120-2, . . . , 120-n) receive an advertising packet broadcast by the BMU (130) and analyze information included in the payload of the advertising packet to determine the CMUs from which transmission failed during the first transmission period.

The CMU from which transmission has failed then checks all the CMUs that failed to transmit, including itself, determines its allocated time slot (i.e., a time slot allocated to itself during the second transmission period) in the second transmission period based on the transmission priority, and retransmits the cell monitoring information during its time slot.

For example, as illustrated in FIG. 4, if only one CMU (CMU #2) fails to transmit, the transmission priority is meaningless, and CMU #2 determines all time slots in the second transmission period as its own time slots and repeatedly retransmits its cell monitoring information during all time slots of the second transmission period.

If CMUs #2, #9, and #16 among 16 CMUs fail to transmit, CMU #2, CMU #9, and CMU #16 each determine their own time slot based on the transmission priority, and transmit cell monitoring information during their own time slots in the second transmission period.

For example, if the transmission priority is set as CMU #2, CMU #9, and CMU #16, CMU #2 is allocated 6 time slots out of a total of 16 time slots in the second transmission period, and CMU #9 and CMU #16 are each allocated 5 time slots. Then, according to a preset transmission sequence algorithm, CMU #2 retransmits 6 consecutive times, CMU #9 retransmits 5 consecutive times, and CMU #16 retransmits 5 consecutive times, or CMU #2, CMU #9, and CMU #16 retransmit sequentially 5 times each, with CMU #2 finally retransmitting 6 times.

According to an embodiment of the present disclosure, time slots in the second transmission period are allocated based on the number of CMUs from which transmission has failed and the transmission priority, thereby differentially distributing the time slots among the plurality of CMUs from which transmission has failed.

Furthermore, the transmission priority may be set higher as the distance between the corresponding CMU and the BMU is greater, or may be set higher as the number of transmission failures of the corresponding CMU is higher, thereby assigning a higher transmission priority to CMUs with a higher likelihood of transmission failure, thus improving the communication success rate.

In addition, based on the number of retransmission failures of the CMU from which transmission has failed being equal to or greater than a preset threshold, the BMU (130) may diagnose the CMU as defective and notify a user, thereby preventing potential safety accidents in advance.

As used in the present disclosure (especially in the appended claims), the terms “a/an” and “the” include both singular and plural referents, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps constituting the method according to an embodiment of the present disclosure may be performed in an appropriate order unless a specific order is described or otherwise specified. In other words, the present disclosure is not necessarily limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example embodiments described above or by the use of such terms unless limited by the appended claims. Also, it should be apparent to those having ordinary skill in the art that various modifications, combinations, and alternations may be made depending on design conditions and factors within the scope of the appended claims or equivalents thereof.

The present disclosure is thus not limited to the embodiments described above, and rather intended to include the following appended claims, and all modifications, equivalents, and alternatives falling within the spirit and scope of the following claims.

What is claimed is:

1. A wireless battery management system, comprising:
a plurality of cell monitoring units (CMUs) configured to monitor a plurality of battery cells; and
a battery management unit (BMU) configured to perform wireless communication with the plurality of CMUs and manage the plurality of CMUs,
wherein the BMU is further configured to:
request the plurality of CMUs to transmit cell monitoring information of the plurality of battery cells, and
based on a failure of transmission of the cell monitoring information from at least one CMU among the plurality of CMUs, preferentially request retransmission of the cell monitoring information from the at least one CMU from which the transmission has failed.

2. The wireless battery management system according to claim 1, wherein:
the BMU is further configured to broadcast, to the plurality of CMUs, an advertising packet requesting the transmission of the cell monitoring information;
each CMU of the plurality of CMUs is configured to transmit the cell monitoring information to the BMU during a first transmission period; and
based on the failure of the transmission from the at least one CMU, the BMU is further configured to broadcast, to the plurality of CMUs, an advertising packet comprising identification information of the at least one CMU from which transmission has failed, and the at least one CMU from which transmission has failed is configured to retransmit the cell monitoring information to the BMU during a second transmission period.

3. The wireless battery management system according to claim 1, wherein:
the BMU is further configured to broadcast, to the plurality of CMUs, an advertising packet requesting the transmission of the cell monitoring information;
each CMU of the plurality of CMUs is configured to transmit the cell monitoring information to the BMU during a first transmission period;
based on that there are two or more CMUs from which the transmission has failed, the BMU is further configured to broadcast an advertising packet comprising identification information of the two or more CMUs from which the transmission has failed; and
each CMU of the two or more CMUs from which the transmission has failed is configured to retransmit the cell monitoring information to the BMU during a corresponding time slot of a second transmission period, wherein the corresponding time slot of the second transmission period is assigned to each CMU, among the two or more CMUs from which the transmission has failed, based on a transmission priority.

4. The wireless battery management system according to claim 3, wherein time slots of the second transmission period are differentially assigned to the two or more CMUs from which the transmission has failed based on the transmission priority.

5. The wireless battery management system according to claim 3, wherein the transmission priority is determined based on a transmission distance between the BMU and a corresponding CMU among the two or more CMUs.

6. The wireless battery management system according to claim 3, wherein the transmission priority is determined based on a number of transmission failures from a corresponding CMU among the two or more CMUs.

7. The wireless battery management system according to claim 2, wherein the advertising packet comprising the identification information of the at least one CMU from which the transmission has failed includes an Advertising Indication (ADV_IND) packet.

8. The wireless battery management system according to claim 2, wherein the advertising packet comprising the identification information of the at least one CMU from which the transmission has failed comprises the identification information of the at least one CMU from which the transmission has failed in a form of a flag in a payload.

9. The wireless battery management system according to claim 2, wherein the identification information of the at least one CMU from which the transmission has failed includes node information of the at least one CMU from which the transmission has failed.

10. The wireless battery management system according to claim 1, wherein the BMU is further configured to diagnose the at least one CMU from which the transmission has failed as defective based on a number of retransmission failures by the at least one CMU being equal to or greater than a preset threshold.

11. A method of operating a wireless battery management system, the method comprising:
requesting, by a battery management unit (BMU), transmission of cell monitoring information from a plurality of cell monitoring units (CMUs);
transmitting, by each CMU of the plurality of CMUs, the cell monitoring information to the BMU during a first transmission period;
preferentially requesting, by the BMU and based on a failure of the transmission from at least one CMU, retransmission of the cell monitoring information from the at least one CMU from which transmission has failed; and
retransmitting, by the at least one CMU from which transmission has failed, the cell monitoring information to the BMU during a second transmission period.

12. The method according to claim 11, wherein:
requesting the transmission of the cell monitoring information comprises:
broadcasting, by the BMU, to the plurality of CMUs, an advertising packet requesting the transmission of the cell monitoring information, and
preferentially requesting the retransmission of the cell monitoring information comprises broadcasting, by the BMU, to the plurality of CMUs, an advertising packet comprising identification information of the at least one CMU from which transmission has failed.

13. The method according to claim 11, wherein requesting the transmission of the cell monitoring information comprises:
broadcasting, by the BMU, to the plurality of CMUs, an advertising packet requesting the transmission of the cell monitoring information; and
based on that there are two or more CMUs from which the transmission has failed,
preferentially requesting the retransmission of the cell monitoring information comprises broadcasting, by the BMU, to the plurality of CMUs an advertising packet comprising identification information of the two or more CMUs from which transmission has failed, and
wherein retransmitting the cell monitoring information to the BMU comprises retransmitting, by each CMU of the two or more CMUs from which transmission has failed, the cell monitoring information to the BMU during a corresponding time slot of a second transmission period, the corresponding time slot of the second transmission period being set based on a transmission priority.

14. The method according to claim 13, wherein time slots of the second transmission period are differentially distributed to the two or more CMUs from which the transmission has failed based on the transmission priority.

15. The method according to claim 13, wherein the transmission priority is higher based on a transmission distance between a corresponding CMU and the BMU being greater.

16. The method according to claim 13, wherein the transmission priority is higher based on a number of transmission failures from a corresponding CMU being higher.

17. The method according to claim 12, wherein the advertising packet comprising the identification information of the at least one CMU from which transmission has failed is an Advertising Indication (ADV_IND) packet.

18. The method according to claim 12, wherein the advertising packet comprising the identification information of the at least one CMU from which the transmission has failed comprises the identification information of the at least one CMU from which the transmission has failed in a form of a flag in a payload.

19. The method according to claim 12, wherein the identification information of the at least one CMU from which the transmission has failed includes node information of the at least one CMU from which the transmission has failed.

20. The method according to claim 11, further comprising, by the BMU, diagnosing the at least one CMU from which the transmission has failed as defective based on a number of retransmission failures by the at least one CMU being equal to or greater than a preset threshold.
